(19) United States
(12) Patent Application Publication
(10) Pub. No.: US 2007/0210712 A1
(43) Pub. Date: Sep. 13, 2007

(54) Surface-discharge-type plasma display panel

(75) Inventors: Takashi Miyata, Yamanashi (JP); Yoshihiko Kamo, Yamanashi (JP); Hirotoshi Tabuchi, Yamanashi (JP); Hiroaki Tokairin, Yamanashi (JP)

Correspondence Address: ARENT FOX PLLC, 1050 CONNECTICUT AVENUE, N.W., SUITE 400, WASHINGTON, DC, 20036, US

(73) Assignee: PIONEER CORPORATION

(21) Appl. No.: 11/713,717

(22) Filed: Mar. 5, 2007

(30) Foreign Application Priority Data
Mar. 10, 2006 (JP) 2006-066129
Mar. 10, 2006 (JP) 2006-066130

(51) Int. Cl. H01J 17/49

(52) U.S. Cl. 313/587; 313/582; 313/583

(57) ABSTRACT

For improvement in the performance of a PDP, a dielectric layer, deposited on the inner face of the front glass substrate of the PDP and covering row electrode pairs, is formed of a dielectric material having a relative dielectric constant of 9 or less, and a protective layer overlying the dielectric layer includes a magnesium oxide crystal causing a cathode-luminescence emission having a peak within a wavelength range of 200 nm to 300 nm upon excitation by electron beams, and discharge gas filling the discharge space includes 10% or more xenon by volume.

### BACKGROUND OF THE INVENTION

1. Field of the Invention

This invention relates to the structure of surface-discharge-type plasma display panels.

The present application claims priority from Japanese Applications No. 2006-066129 and No. 2006-066130, the disclosure of which is incorporated herein by reference.

2. Description of the Related Art

A surface-discharge-type alternating-current plasma display panel (hereinafter referred to as “PDP”) includes two opposing glass substrates placed on either side of a discharge space. On one of the two glass substrates a plurality of row electrode pairs, which extend in the row direction, are regularly arranged in the column direction and covered by a dielectric layer. On the dielectric layer a magnesium oxide film having the function of protecting the dielectric layer and the function of emitting secondary electrons into the discharge space is formed by a vapor deposition technique. On the other glass substrate, a plurality of column electrodes extending in the column direction are regularly arranged in the row direction, thus forming unit light emission areas (discharge cells) in positions corresponding to the intersections between the row electrode pairs and the column electrodes in the discharge space such that the unit light emission areas are arranged in matrix form over the surface of the panel.

Phosphor layers, to which the primary colors, red, green and blue are applied, are formed in the respective discharge cells.

The discharge space of the PDP is filled with a discharge gas consisting of a gas mixture of neon and xenon.

In the PDP thus structured, an image is displayed by a driving method as described below.

Specifically, the PDP initiates a reset discharge simultaneously between paired row electrodes, and then an address discharge selectively between one of the paired row electrodes and the column electrode. The address discharge results in the distribution, over the panel surface, of light-emitting cells having the deposition of wall charge on the dielectric layer adjoining each discharge cell and no-light-emitting cells in which the wall charge has been erased from the dielectric layer. A sustaining discharge is then produced between the paired row electrodes in the light-emitting cells, resulting in the emission of vacuum ultraviolet light from the xenon included in the discharge gas filling the discharge space. The vacuum ultraviolet light excites the red, green and blue phosphor layers, which then emit visible light so as to generate an image according to image data indicated by an image signal on the panel surface.

A gradation driving method, which is called a subfield method, is adopted for driving the PDP in order to display a halftone image.

With the gradation driving method based on the subfield method, the display period of a frame is constituted of eight subfields in which the relative ratio of luminance is set at 1:2:4:8:16:32:64:128 and in each of which an address period and a sustaining period are set, and these subfields are selectively combined for light emission so as to display an image at 256 levels of luminance.

In a conventional PDP structured as described above, during the sustaining period when it is driven, because a plurality of discharge cells has been selected as the light-emitting cells placed in the lighting state, the application of a sustaining pulse simultaneously causes a discharge in all the light-emitting cells, resulting in the momentary passage of a large amount of electric current, thus increasing the discharge intensity. This increase in the discharge intensity causes a luminance residual image, resulting in degradation in the display quality of the images.

In particular, the occurrence of a luminance residual image is a serious problem for a PDP which repeats discharges many times within a frame display period in order to achieve the gradation display based on the above-described subfield method.

Another subject of longstanding study is the simultaneous achievement of the prevention of a reduction in discharge probability (discharge delay) such as in the sustaining discharge and the improvement of panel luminous efficiency, both of which are impossible in the conventional PDPs structured as described above.

Conventionally, a PDP as disclosed by, for example, Japanese Unexamined Patent Publication No. 2002-93327, in which the concentration of xenon in the discharge gas is increased is suggested as a PDP having a means for improving the luminous efficiency, for example. However, such a simple increase in the xenon concentration alone results in an increase in the time of the discharge delay. In particular, when the PDP is driven by the above-mentioned subfield method, it is unfortunately impossible to ensure the required number of subfields for implementing the subfield method, leading to the impossibility of gradation display of the desired luminance.

### SUMMARY OF THE INVENTION

It is an object of the present invention to solve the technical problems associated with conventional PDPs as described above.

To solve the technical problems, in a best mode for carrying out a surface-discharge-type plasma display panel according to an aspect of the present invention, a PDP has: a pair of substrates facing each other across a discharge space; row electrode pairs and column electrodes provided between the pair of substrates, placed at a distance from each other, and extending in directions at right angles to each other to form unit light emission areas in positions corresponding to intersections in the discharge space; a dielectric layer overlying the row electrode pairs; and a protective layer overlying the dielectric layer and facing the unit light emission areas, wherein the discharge space is filled with a discharge gas, the dielectric layer is formed of a dielectric material having a relative dielectric constant of 9 or less, and the protective layer includes a magnesium oxide crystal that causes a cathode-luminescence emission having a peak within a wavelength range of 200 nm to 300 nm upon excitation by electron beams.

According to the aspect, the dielectric layer is formed of a low-relative-dielectric-constant dielectric material having a relative dielectric constant of 9 or less, thereby restraining the occurrence of a luminance residual image on the panel. In addition, a rise in the breakdown voltage and the occurrence of discharge delay which result from the formation of the dielectric layer of a low-relative-dielectric-constant dielectric material are restrained because the protective layer covering the dielectric layer includes a magnesium oxide crystal that causes a cathode-luminescence emission having a peak within a wavelength range of 200 nm to 300 nm upon excitation by electron beams, which thus makes it possible to simultaneously achieve an improvement in panel residual image characteristics, an improvement in discharge delay characteristics and the prevention of a rise in the breakdown voltage.

The effect of the improvement in the panel residual image characteristics is exerted particularly in a PDP repeatedly producing discharges many times within the discharge period of a frame for the gradation display by the subfield method.

In the PDP according to the aspect, the dielectric material used for forming the dielectric layer is preferably a leadless glass material having a relative dielectric constant of 8 or less. Preferable examples of the leadless glass material include a Zn—B—Si alkali-containing glass material having a relative dielectric constant of 7 or less, and a Zn—B—Si alkali-containing glass material having a relative dielectric constant of 6.8, thereby further achieving an improvement in panel residual image characteristics and an improvement in discharge delay characteristics.

In the PDP according to the aspect, the protective layer preferably comprises a thin-film magnesium oxide layer deposited by vapor deposition or by spattering, and a crystalline magnesium oxide layer including a magnesium oxide crystal and deposited and laminated on the thin-film magnesium oxide layer, thereby further achieving an improvement in discharge delay characteristics.

In the PDP according to the aspect, the magnesium oxide crystal is preferably a magnesium oxide single crystal produced by a vapor-phase oxidization technique, thereby further achieving an improvement in discharge delay characteristics.

Further, in the PDP according to the aspect, the magnesium oxide crystal preferably causes a cathode-luminescence emission having a peak within a wavelength range of 230 nm to 250 nm, thereby further achieving an improvement in discharge delay characteristics.

Further, in the PDP according to the aspect, the magnesium oxide crystal preferably has a particle diameter of 2000 or more angstroms, thereby further achieving an improvement in discharge delay characteristics.

To solve the aforementioned technical problems, in a best mode of a surface-discharge-type plasma display panel according to another aspect of the present invention, a PDP has: a pair of substrates facing each other across a discharge space; row electrode pairs and column electrodes provided between the pair of substrates, placed at a distance from each other, and extending in directions at right angles to each other to form unit light emission areas in positions corresponding to the intersections in the discharge space; a dielectric layer overlying the row electrode pairs; and a protective layer overlying the dielectric layer and facing the unit light emission areas, wherein the discharge space is filled with a discharge gas, the dielectric layer is formed of a dielectric material having a relative dielectric constant of 9 or less, the protective layer includes a magnesium oxide crystal that causes a cathode-luminescence emission having a peak within a wavelength range of 200 nm to 300 nm upon excitation by electron beams, and the discharge gas includes 10% or more xenon by volume.

According to this aspect, the discharge gas filling the discharge space is a high-xenon gas including 10% or more xenon by volume, and also the dielectric layer is formed of a low-relatively-dielectric-constant dielectric material having a relative dielectric constant of 9 or less, thereby making it possible to achieve a significant high light emitting efficiency as compared with that in conventional PDPs. In addition, the protective layer covering the dielectric layer includes a magnesium oxide crystal, thus making it possible to eliminate the occurrence of discharge delay which results from then increase in xenon in the discharge gas and the reduction in the relative dielectric constant of the dielectric material, and also to further achieve an improvement in discharge delay characteristics as compared with conventional PDPs.

In the PDP according to the aspect, the dielectric material used for forming the dielectric layer is preferably a leadless glass material having a relative dielectric constant of 8 or less. Preferable examples of the leadless glass material include a Zn—B—Si alkali-containing glass material having a relative dielectric constant of 7 or less, and a Zn—B—Si alkali-containing glass material having a relative dielectric constant of 6.8, thereby further achieving an improvement in panel light-emitting efficiency and an improvement in discharge delay characteristics.

In the PDP according to the aspect, the discharge gas preferably includes 15% xenon by volume, thereby achieving a further improvement in light-emitting efficiency.

In the PDP according to the aspect, the protective layer preferably comprises a thin-film magnesium oxide layer deposited by vapor deposition or by spattering, and a crystalline magnesium oxide layer including a magnesium oxide crystal and deposited and laminated on the thin-film magnesium oxide layer, thereby achieving a further improvement in the discharge delay characteristics of the panel.

In the PDP according to the aspect, the magnesium oxide crystal is preferably a magnesium oxide single crystal produced by a vapor-phase oxidization technique, thereby achieving a further improvement in the discharge delay characteristics of the panel.

Further, in the PDP according to the aspect, the magnesium oxide crystal preferably causes a cathode-luminescence emission having a peak within a wavelength range of 230 nm to 250 nm, thereby achieving a further improvement in the discharge delay characteristics of the panel.

Further, in the PDP according to the aspect, the magnesium oxide crystal preferably has a particle diameter of 2000 or more angstroms, thereby achieving a further improvement in the discharge delay characteristics of the panel.

These and other objects and features of the present invention will become more apparent from the following detailed description with reference to the accompanying drawings.

### BRIEF DESCRIPTION OF THE DRAWINGS

FIG. 1 is a front view illustrating an embodiment of the present invention.

FIG. 2 is a sectional view taken along the V-V line in FIG. 1.

FIG. 3 is a sectional view taken along the W-W line in FIG. 1.

FIG. 4 is a sectional view illustrating a crystalline magnesium layer formed on a thin-film magnesium layer in the embodiment.

FIG. 5 is a sectional view illustrating a thin-filmmagnesium layer formed on a crystalline magnesium layer in the embodiment.

FIG. 6 is a SEM photograph of a magnesium oxide single crystal having a cubic single-crystal structure.

FIG. 7 is a SEM photograph of a magnesium oxide single crystal having a cubic polycrystal structure.

FIG. 8 is a graph showing the residual image characteristics of a conventional PDP for comparison.

FIG. 9 is a graph showing the residual image characteristics of the PDP of the embodiment.

FIG. 10 is a graph showing a comparison between the discharge delay characteristics of the PDP of the embodiment and of a conventional PDP.

FIG. 11 is another graph showing a comparison between the discharge delay characteristics of the PDP of the embodiment and of a conventional PDP.

FIG. 12 is a graph showing a comparison between the light-emitting efficiencies of the PDP of the embodiment and of a conventional PDP.

FIG. 13 is a graph showing the relationship between the particle size of a magnesium oxide single-crystal and the wavelength of a CL emission in the embodiment.

FIG. 14 is a graph showing the relationship between the particle size of a magnesium oxide single-crystal and the intensity of a CL emission at 235 nm in the embodiment.

FIG. 15 is a graph showing the state of the wavelength of a CL emission from a magnesium oxide layer formed by vapor deposition.

FIG. 16 is a graph showing the relationship between the discharge delay and the peak intensity of a CL emission at 235 nm from the magnesium oxide single crystal.

FIG. 17 is a graph showing a comparison between the discharge delay characteristics of the case when the protective layer is constituted only of the magnesium oxide layer formed by vapor deposition and that when the protective layer has a double layer structure made up of a crystalline magnesium layer and a thin-film magnesium layer formed by vapor deposition.

### DETAILED DESCRIPTION OF THE PREFERRED EMBODIMENT

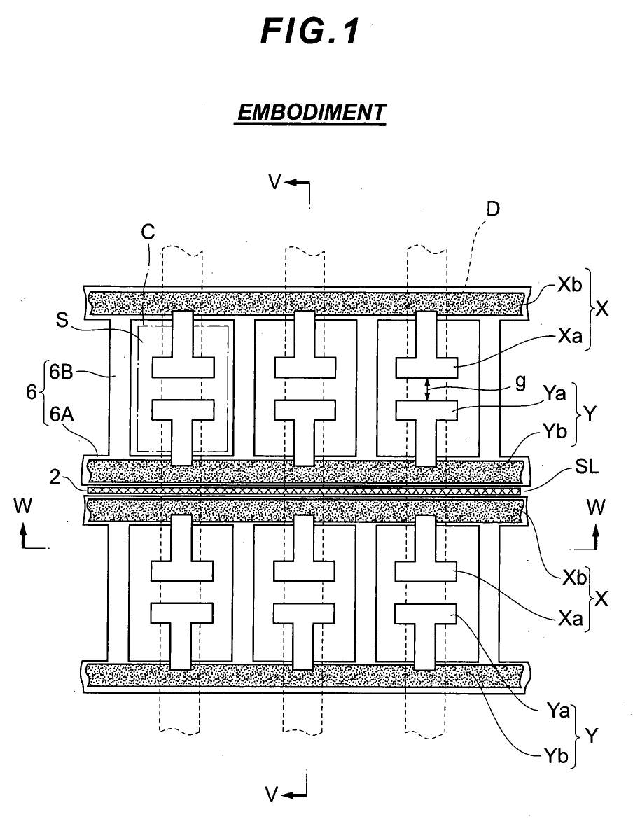

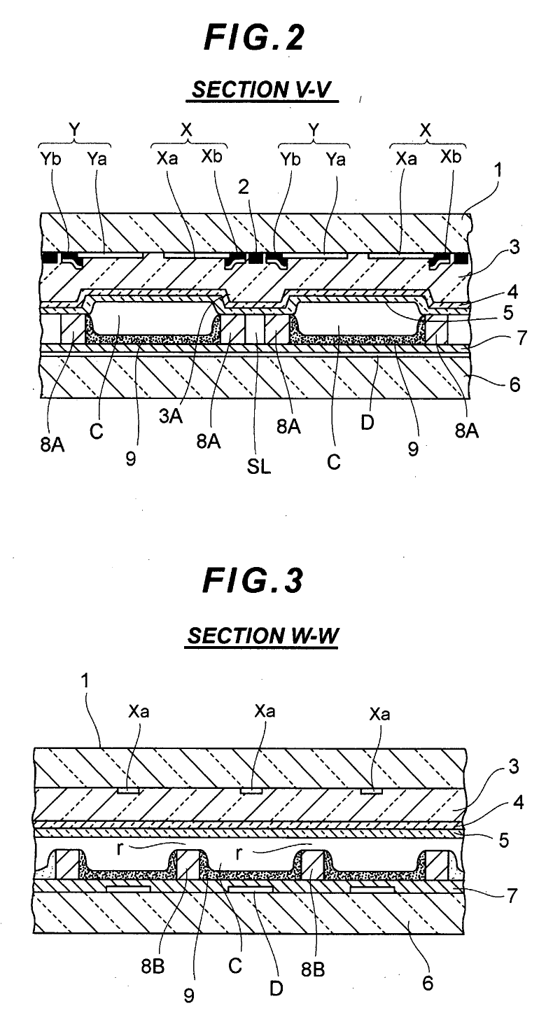

FIGS. 1 to 3 illustrate an example of a preferred embodiment of the PDP according to the present invention. FIG. 1 is a schematic front view of the PDP in the embodiment example. FIG. 2 is a sectional view taken along the V-V line in FIG. 1. FIG. 3 is a sectional view taken along the W-W line in FIG. 1.

The PDP in FIGS. 1 to 3 has a plurality of row electrode pairs (X, Y) arranged in parallel on the rear-facing face of a front glass substrate 1 serving as the display surface so as to extend in the row direction of the front glass substrate 1 (the right-left direction in FIG. 1).

A row electrode X is composed of T-shaped transparent electrodes Xa formed of a transparent conductive film made of ITO or the like, and a bus electrode Xb formed of a metal film extending in the row direction of the front glass substrate 1 and connected to the narrow proximal ends of the transparent electrodes Xa.

Likewise, a row electrode Y is composed of T-shaped transparent electrodes Ya formed of a transparent conductive film made of ITO or the like, and a bus electrode Yb formed of a metal film extending in the row direction of the front glass substrate 1 and connected to the narrow proximal ends of the transparent electrodes Ya.

The row electrodes X and Y are arranged in alternate positions in the column direction of the front glass substrate 1 (the vertical direction in FIG. 1). Each of the transparent electrodes Xa and Ya, which are regularly spaced along the associated bus electrodes Xb and Yb facing each other, extends out toward its counterpart in the row electrode pair, so that the wide distal ends of the transparent electrodes Xa and Ya face each other with a discharge gap g having a required width in between.

A black- or dark-colored light absorption layer (light-shield layer) 2, which extends in the row direction along the back-to-back bus electrodes Xb, Yb of the adjacent row electrode pairs (X, Y) in the column direction, is formed between these bus electrodes Xb and Yb on the rear-facing face of the front glass substrate 1.

In addition, a dielectric layer 3 is formed on the rear-facing face of the front glass substrate 1 so as to overlie the row electrode pairs (X, Y). On the rear-facing face of the dielectric layer 3, an additional dielectric layer 3A projecting toward the rear from the dielectric layer 3 is formed in a portion facing the back-to-back bus electrodes Xb, Yb of the adjacent row electrode pairs (X, Y) and facing the area between the back-to-back bus electrodes Xb, Yb so as to extend in parallel to these bus electrodes Xb, Yb.

The dielectric layer 3 and the additional dielectric layer 3A are formed of a low ∈ dielectric material having a relative dielectric constant of 9 or less, such as a leadless glass material including alkali, as described later.

On the rear-facing faces of the dielectric layer 3 and the additional dielectric layers 3A, a magnesium oxide layer 4 of a thin film form (hereinafter referred to as “thin-film MgO layer 4”) is formed by vapor deposition or by spattering and covers the entire rear-facing faces of the dielectric layer 3 and the additional dielectric layers 3A.

In turn, a magnesium oxide layer 5 including a magnesium oxide crystal (hereinafter referred to as “crystalline MgO layer 5”), as described in detail later, is formed on the rear-facing face of the thin-film MgO layer 4. The magnesium oxide crystal causes a cathode-luminescence emission (CL emission) having a peak within a wavelength range of 200 nm to 300 nm (more specifically, of 230 nm to 250 nm, around 235 nm) upon excitation by electron beams.

The crystalline MgO layer 5 is formed on the entire rear-facing face or, for example, a part of the rear-facing face of the thin-film MgO layer 4 that faces the discharge cells, which will be described later. (In the example illustrated in FIGS. 1 to 3, the crystalline MgO layer 5 is formed on the entire rear-facing face of the thin-film MgO layer 4.)

The front glass substrate 1 is placed parallel to a back glass substrate 6. Column electrodes D are arranged parallel to each other at predetermined intervals on the front-facing face (the face facing toward the display surface of the PDP) of the back glass substrate 6. Each of the column electrodes D extends in a direction at right angles to the row electrode pairs (X, Y) (i.e. in the column direction) on a portion of the back glass substrate 6 opposite to the paired transparent electrodes Xa and Ya of each row electrode pair (X, Y).

On the front-facing face of the back glass substrate 6, a white column-electrode protective layer (dielectric layer) 7 overlies the column electrodes D, and in turn partition wall units 8 are formed on the column-electrode protective layer 7.

Each of the partition wall units 8 is formed in an approximate ladder shape made up of a pair of transverse walls 8A and vertical walls 8B. The pair of transverse walls 8A extends in the row direction in the respective positions opposite to the bus electrodes Xb and Yb of each row electrode pair (X, Y). Each of the vertical walls 8B extends in the column direction between the pair of transverse walls 8A in a mid-position between the adjacent column electrodes D. The partition wall units 8 are regularly arranged in the column direction in such a manner as to form an interstice SL extending in the row direction between the back-to-back transverse walls 8A of the adjacent partition wall sets 8.

The ladder-shaped partition wall units 8 partition the discharge space S defined between the front glass substrate 1 and the back glass substrate 6 into quadrangular areas to form discharge cells C in positions each corresponding to the paired transparent electrodes Xa and Ya of each row electrode pair (X, Y).

A phosphor layer 9 overlies five faces facing the discharge space S: the four side faces of the transverse walls 8A and the vertical walls 8B of the partition wall unit 8 and the face of the column-electrode protective layer 7. The colors of the phosphor layers 9 are arranged such that the three primary colors, red, green and blue, are arranged in order in the row direction for each discharge cell C.

The crystalline MgO layer 5 (or the thin-film MgO layer 4 when the crystalline MgO layer 5 is formed only on a portion of the rear-facing face of the thin-film MgO layer 4 facing each discharge cell C) overlying the additional dielectric layer 3A (see FIG. 2) is in contact with the front-facing face of each of the transparent walls 8A of the partition wall units 8, to block off the discharge cell C and the interstice SL from each other. However, the crystalline MgO layer 5 is out of contact with the front-facing face of the vertical wall 8B (see FIG. 3), to form a clearance r therebetween, so that the adjacent discharge cells C in the row direction interconnect with each other by means of the clearance r.

The discharge space S is filled with discharge gas of a Ne—Xe gas mixture including 10% or more xenon by volume, as described later.

The dielectric layer 3 and the additional dielectric layer 3A of the PDP are formed of a dielectric material with a relative dielectric constant of 9 or less, as described earlier. An example of such a dielectric material used include a leadless alkali glass material from among the following examples: a Zn—B—Si alkali glass material, such as model number TS-1000C produced by Nippon Electric Glass Corporation (relative dielectric constant: 6.8); a SiO₂—B₂O₃—ZnO alkali glass material, such as model number G3-4156 produced by Okuno Chemical Industries Corporation (relative dielectric constant: 7.5); and an SiO₂—B₂O₃—ZnO—BaO glass material, such as mode number YFT506 produced by Asahi Glass Corporation (relative dielectric constant: 8.9).

For the buildup of the crystalline MgO layer 5 of the above PDP, a spraying technique, electrostatic coating technique or the like is used to cause the MgO crystal as described earlier to adhere to the rear-facing face of the thin-film MgO layer 4 overlying the dielectric layer 3 and the additional dielectric layers 3A.

The embodiment describes the case where the thin-film MgO layer 4 is formed on the rear-facing faces of the dielectric layer 3 and additional dielectric layer 3A and then the crystalline MgO layer 5 is formed on the rear-facing face of the thin-film MgO layer 4. Alternatively, the crystalline MgO layer 5 may be first formed on the rear-facing faces of the dielectric layer 3 and additional dielectric layers 3A and then the thin-film MgO layer 4 may be formed on the rear-facing face of the crystalline MgO layer 5.

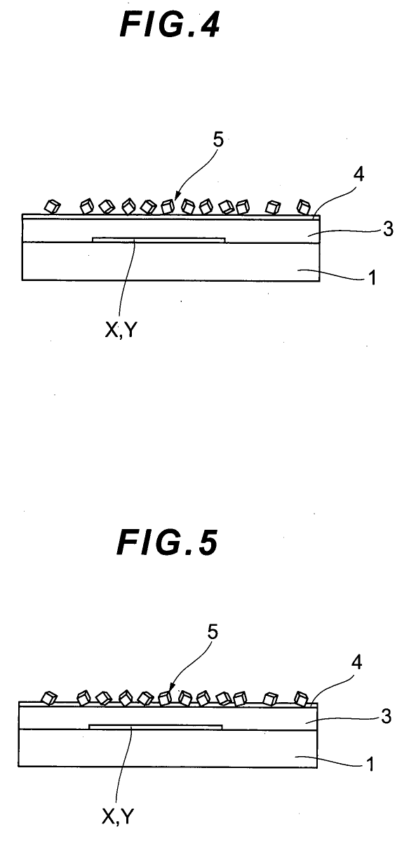

FIG. 4 shows the state when the thin-film MgO layer 4 is first formed on the rear-facing face of the dielectric layer 3 and then MgO crystal is affixed to the rear-facing face of the thin-film MgO layer 4 to form the crystalline MgO layer 5 by use of a spraying technique, electrostatic coating technique or the like.

FIG. 5 shows the state when the MgO crystal is affixed to the rear-facing face of the dielectric layer 3 to form the crystalline MgO layer 5 by use of a spraying technique, electrostatic coating technique or the like, and then the thin-film MgO layer 4 is formed.

The crystalline MgO layer 5 of the PDP is formed by use of the following materials and method.

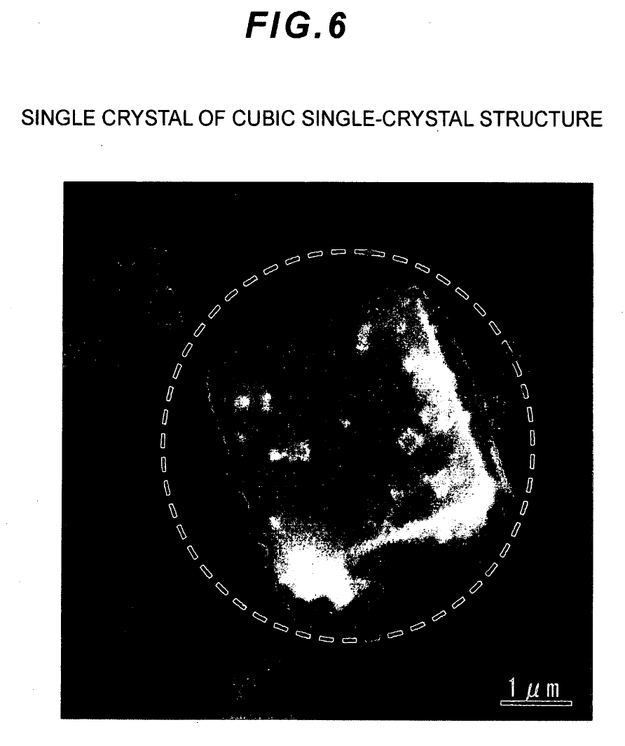

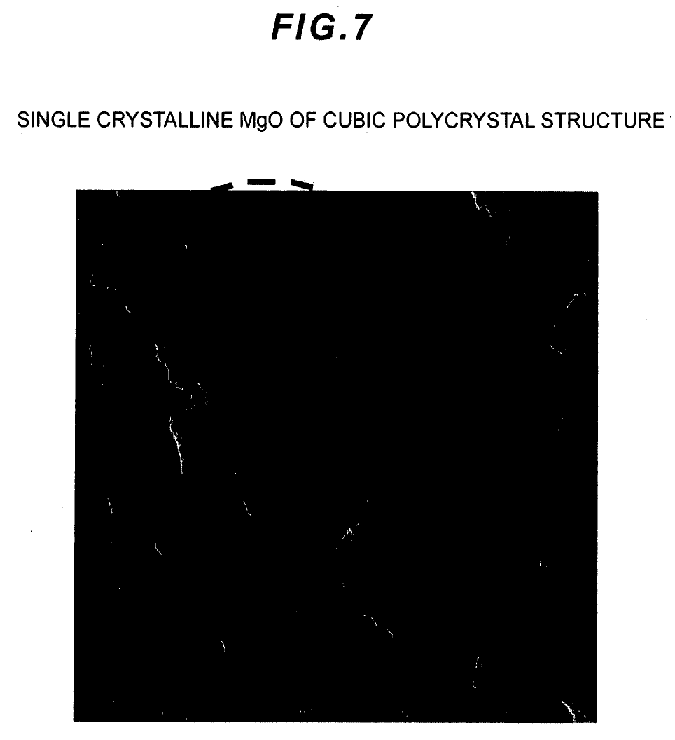

That is to say, examples of MgO crystal, used as materials for forming the crystalline MgO layer 5 and causing a CL emission having a peak within a wavelength range of 200 nm to 300 nm (more specifically, of 230 nm to 250 nm, around 235 nm) by being excited by an electron beam, include single crystal of magnesium which is obtained by performing vapor-phase oxidization on magnesium steam generated by heating magnesium (this single crystal of magnesium are hereinafter referred to as “vapor-phase MgO single crystal”). Examples of the vapor-phase MgO single crystal include MgO single crystal having a cubic single-crystal structure as illustrated in the SEM photograph in FIG. 6, and MgO single crystal having a structure of cubic crystal fitted to each other (i.e. a cubic polycrystal structure) as illustrated in the SEM photograph in FIG. 7.

The vapor-phase MgO single crystal contributes to an improvement of the discharge characteristics such as a reduction in discharge delay as described later.

As compared with magnesium oxide obtained by other methods, the vapor-phase MgO single crystal have the features of being of a high purity, taking a microscopic particle form, causing less particle agglomeration, and the like.

The vapor-phase MgO single crystal used in the embodiment has an average particle diameter of 500 or more angstroms (preferably, 2000 or more angstroms) based on a measurement using the BET method.

Note that the preparation of the vapor-phase MgO single crystal is described in “Preparation of magnesia powder using a vapor phase method and its properties” (Zairyou (Materials) Vol. 36, No. 410, pp. 1157-1161, November 1987), and the like.

The crystalline MgO layer 5 is formed, for example, by the affixation of the vapor-phase MgO single crystal by use of a spraying technique, electrostatic coating technique or the like as described earlier.

In the above-mentioned PDP, a reset discharge, an address discharge and a sustaining discharge for generating an image are produced in the discharge cell C.

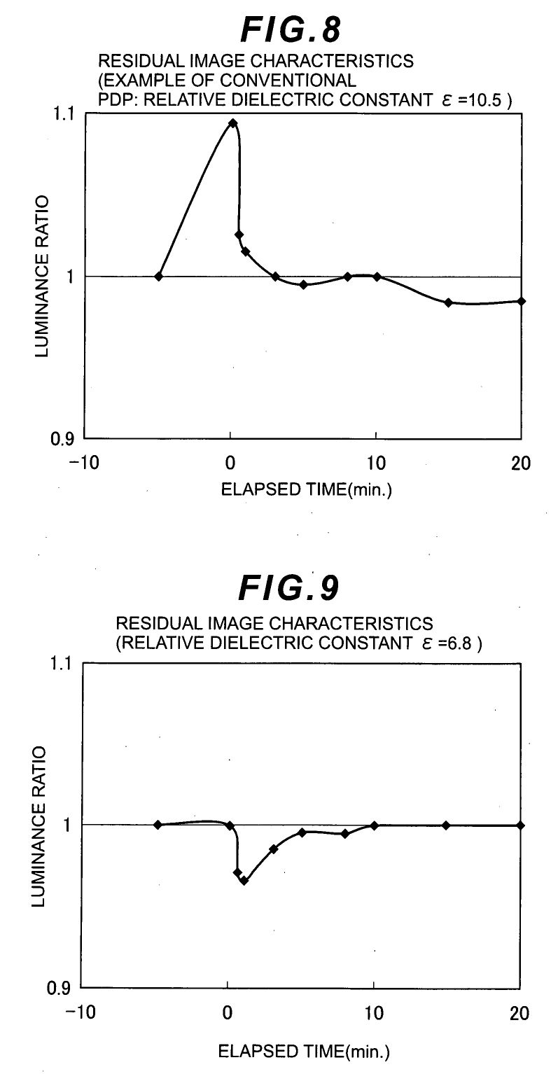

FIGS. 8 and 9 are graphs showing comparisons between a luminance residual image occurring when a PDP provided with a conventional dielectric layer generates an image, and a luminance residual image occurring when the PDP structured according to the present invention generates an image.

The graph in FIG. 8 shows the state of the luminance residual image occurring (the luminance ratio between the area of the screen in which a residual image occurs and the area surrounding this area) in the conventional PDP in which a dielectric layer is formed of a Pb—B—Si non-alkali glass material, including lead, having a relative dielectric constant ∈ of 10.5 (model number LS-3232F produced by Nippon Electric Glass Corporation), and the protective layer overlying the dielectric layer has a thin-film magnesium oxide layer and a crystalline magnesium oxide layer, and the discharge gas sealed therein consists of a Ne—Xe gas mixture including 15% xenon by volume.

The graph in FIG. 9 shows the state of a luminance residual image occurring in the PDP structured according to the present invention in which the dielectric layer 3 is formed of a Zn—B—Si alkali glass material without lead having a relative dielectric constant ∈ of 6.8 (model number TS-1000C produced by Nippon Electric Glass Corporation), and the protective layer overlying the dielectric layer 3 has the thin-film MgO layer 4 and the crystalline MgO layer 5, and the discharge gas sealed therein consists of a Ne—Xe gas mixture including 15% xenon by volume.

It is seen from a comparisons between the graphs in FIGS. 8 and 9 that the luminance residual image occurring when the PDP of the aforementioned structure generates an image (the luminance ratio shown by the vertical axis of FIG. 9) is lower than the luminance residual image occurring when the conventional PDP generates an image (the luminance ratio shown by the vertical axis of FIG. 8), and the use of a low ∈ dielectric material with a relative dielectric constant ∈ of 9 or less to form the dielectric layer 3 causes a reduction in luminance residual image occurring at the time of image generation.

Specifically, in a PDP having a dielectric layer formed of a high ∈ dielectric material with a relative dielectric constant C exceeding 9 as conventionally structured, a discharge is initiated simultaneously in a plurality of light-emitting cells upon the application of a drive pulse (sustaining pulse), leading to the momentary passage of a large amount of electric current, resulting in a luminance residual image. In particular, a PDP repeatedly producing discharges many times within the display period of a frame in order to achieve the gradation display by the subfield method may possibly be subject to a reduction in the display quality of an image due to the luminance residual image. However, as the PDP structured according to the present invention includes the use of a low ∈ dielectric material with a relative dielectric constant ∈ of 9 or less to form the dielectric layer 3, the occurrence of a luminance residual image is inhibited.

In addition, the use of the low ∈ dielectric material to form the dielectric layer 3 allows for an improvement in panel luminous efficiency.

The Simple provision of a dielectric layer 3 formed of the low C dielectric material causes a rise in breakdown voltage and a discharge delay. However, the rise in breakdown voltage and the discharge delay are restrained because the protective layer overlying the dielectric layer 3 has a crystalline magnesium oxide layer including the vapor-phase MgO single crystal. The combination of a dielectric layer 3 of a low relative dielectric constant and a crystalline MgO layer 5 makes it possible for the PDP structured according to the present invention to simultaneously achieve the improvement of the panel residual image characteristics, the improvement of the discharge delay characteristics and the prevention of a rise in the breakdown voltage.

It is thought that the improvement of the residual image characteristic in the PDP structured according to the present invention is accounted for by the following reasons.

When in a PDP having a dielectric layer formed of a dielectric material of a high relative dielectric constant, a strong electric field occurs at the initiation of a discharge, if the protective layer includes an MgO crystal, an electron is trapped in an electron trap site existing in the MgO crystal so as to make the inside of the MgO crystal become negatively charged, so that the surface of the MgO crystal is sheathed with positive ions resulting from the discharge, there by preventing the usual discharge from growing, thus producing a difference in display luminance among parts of the panel surface. It is surmised that this difference in display luminance is perceived as a residual image.

In contrast with this, it is thought that, when the dielectric layer 3 is formed of a low ∈ dielectric material as in the PDP structured according to the present invention, the amount of electric charge which the dielectric layer 3 is capable of carrying is reduced, so that the strength of the electric field produced decreases. As a result, an electron is trapped in an electron trap site positioned relatively near the surface of the MgO crystal, not the electron trap site positioned deep inside the MgO crystal.

It is thus thought that, because the electron trapped in the electron trap site near the surface of the MgO crystal is relatively readily released from the trapped state by the discharge, the effect of the electron on the panel γ characteristics is also reduced, so that a difference in display luminance on the panel surface is not easily produced, resulting in a reduction in the occurrence of a luminance residual image as compared with the conventional case.

In addition, the PDP structured according to the present invention has a discharge current of a low density due to the use of the low ∈ dielectric material to form the dielectric layer 3. This moderates the sputtering for depositing the MgO layer forming part of the protective layer. As a result, a significant improvement in residual image characteristics is achieved, and also an enhancement in panel life is achieved.

Further, the discharge gas filling the discharge space S of the PDP according to the present invention is a high-xenon gas including 10% or more xenon by volume, and the dielectric layer 3 and the additional dielectric layer 3A are formed of a low ∈ dielectric material of a relative dielectric constant ∈ of 9 or less. Thereby, it is possible for the PDP according to the present invention to achieve a higher light-emitting efficiency than that in the conventional PDP. In addition, the protective layer overlying the dielectric layer 3 and the additional dielectric layers 3A has the crystalline MgO layer 5 including the vapor-phase MgO single crystal, whereby the PDP according to the present invention can overcome the problem of degradation in discharge delay characteristics involved in an increase in the amount of xenon included in the discharge gas and in a reduction in the relative dielectric constant of the dielectric layer 3, and also can achieve a further improvement in the discharge delay characteristics as compared with the conventional PDP.

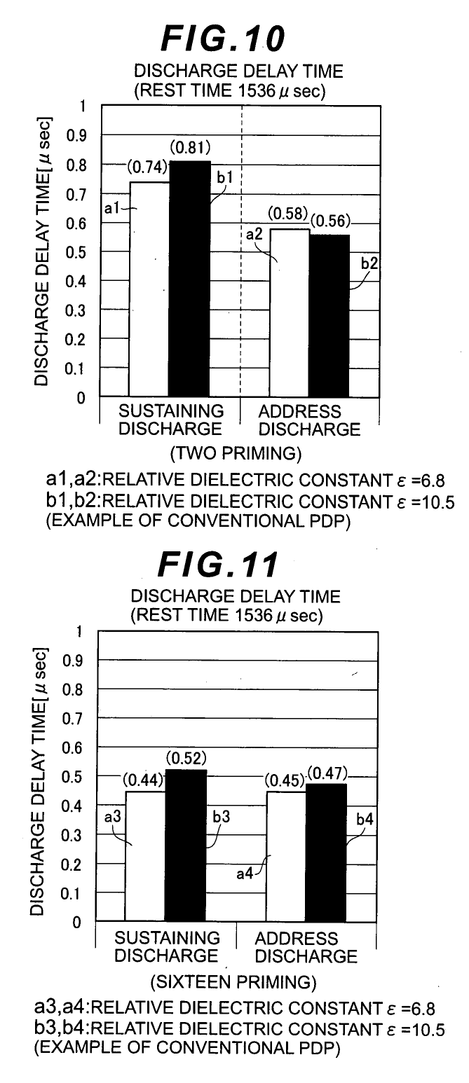

FIGS. 10 and 11 are graphs showing comparisons between discharge delay time in a PDP provided with a conventional dielectric layer and discharge delay time in the PDP structured according to the present invention. FIG. 10 shows a comparison of the discharge delay time when priming occurs twice and FIG. 11 shows a comparison of the discharge delay time when priming occurs 16 times. In each of FIGS. 10 and 11, the left side shows the discharge delay time in a sustaining discharge and the right side shows the discharge delay time in an address discharge.

Graphs a1, a2, a3 and a4 in FIGS. 10 and 11 show the discharge delay time in the PDP structured according to the present invention in which the dielectric layer 3 is formed of a leadless, Zn—B—Si alkali glass material with a relative dielectric constant ∈ of 6.8 (model number TS-1000C produced by Nippon Electric Glass Corporation), and the protective layer overlying this dielectric layer has the thin-film MgO layer 4 and the crystalline MgO layer 5, and the discharge gas sealed therein is an Ne—Xe gas mixture including 15% xenon by volume.

Graphs b1, b2, b3 and b4 in FIGS. 10 and 11 show the discharge delay time in a conventional PDP structured in which the dielectric layer is formed of a Pb—B—Si non-alkali glass material, including lead, with a relative dielectric constant ∈ of 10.5 (model number LS-3232F produced by Nippon Electric Glass Corporation), and a protective layer overlying this dielectric layer has a thin-film MgO layer and a crystalline MgO layer, and the discharge gas sealed therein is an Ne—Xe gas mixture including 15% xenon by volume.

It is seen from FIGS. 10 and 11 that the PDP structure according to the present invention is approximately equivalent or somewhat improved in the discharge delay time in the address discharge, sustaining discharge and the like as compared with that in conventional PDP.

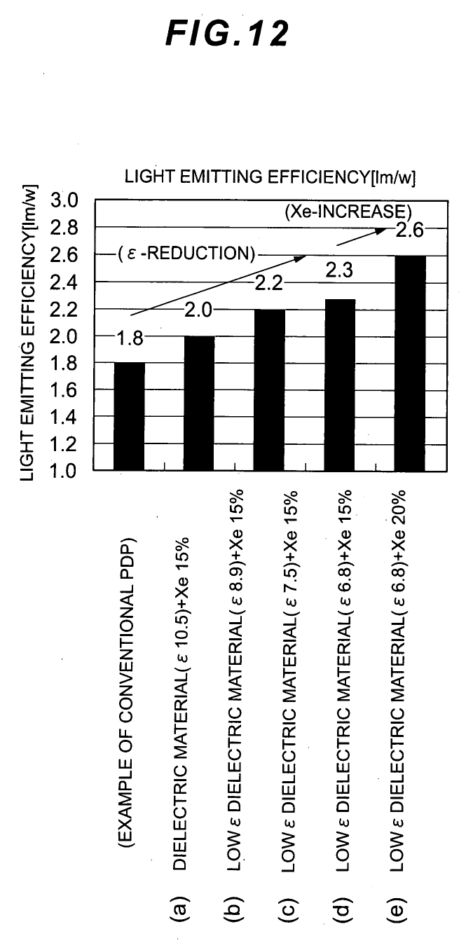

FIG. 12 is a graph showing a comparison between the light-emitting efficiency in a PDP provided with a conventional dielectric layer and the light-emitting efficiency in the PDP structured according to the present invention. In FIG. 12, graph (a) shows the light-emitting efficiency of the conventional PDP in which the dielectric layer is formed of a Pb—B—Si non-alkali glass material including lead having a relative dielectric constant ∈=10.5 and an Ne—Xe discharge gas including 15vol % xenon is sealed therein; graph (b) shows the light-emitting efficiency of the PDP structured according to the present invention in which the dielectric layer 3 is formed of a leadless, Zn—B—Si alkali glass material having a relative dielectric constant ∈=8.9 and an Ne—Xe discharge gas including 15vol % xenon is sealed therein; graph (c) shows the light-emitting efficiency of the PDP structured according to the present invention in which the dielectric layer 3 is formed of a leadless, Zn—B—Si alkali glass material having a relative dielectric constant ∈=7.5 and an Ne—Xe discharge gas including 15vol % xenon is sealed therein; graph (d) shows the light-emitting efficiency of the PDP structured according to the present invention in which the dielectric layer 3 is formed of a leadless, Zn—B—Si alkali glass material having a relative dielectric constant ∈=6.8 and an Ne—Xe discharge gas including 15vol % xenon is sealed therein; and graph (e) shows the light-emitting efficiency of the PDP structured according to the present invention in which the dielectric layer 3 is formed of a leadless, Zn—B—Si alkali glass material having a relative dielectric constant ∈=6.8 and an Ne—Xe discharge gas including 20vol % xenon is sealed therein, in each of which cases the protective layer overlying the dielectric layer has the thin-film MgO layer and the crystalline MgO layer.

It is seen from FIG. 12 that a PDP with the discharge space S filled with a discharge gas using a high xenon gas including 10 vol % or more xenon has a high light-emitting efficiency, in which the light emitting efficiency increases with the increase in the concentration of xenon in the discharge gas, and that the PDP according to the present invention uses a low ∈ dielectric material of a relative dielectric constant ∈ of 9 or less to form the dielectric layer 3, thereby achieving a high light-emitting efficiency as compared with that in the conventional PDP.

The following is also seen from the results of FIGS. 10 to 12.

Specifically, if in a PDP the concentration of xenon in the discharge gas is simply increased and the dielectric layer is formed of a low ∈ dielectric material for the purpose of the improvement of the light emitting efficiency, the discharge delay characteristics are worsened, and in particular, when the PDP is driven by the subfield method, the PDP is incapable of producing the gradation display at a desired luminance. However, in the PDP structured according to the present invention, the protective layer covering the dielectric layer 3 has the crystalline MgO layer 5, thereby simultaneously overcoming the two challenges of achieving a high light-emitting efficiency resulting from an increase in xenon in the discharge gas and a reduction in the relative dielectric constant of the dielectric layer 3, and of not only preventing the discharge delay characteristics from suffering the accompanying deterioration, but also improving them.

In addition, the PDP structured according to the present invention has the further advantageous effect that, when the reset discharge prior to the address discharge is initiated in the discharge cell C, the priming effect caused by the reset discharge is maintained for a long duration as a result of the crystalline MgO layer 5 formed in the discharge cell C, leading to a fast response of the address discharge.

Next, a description will be given of the reason why the PDP structured according to the present invention has improved discharge delay characteristics due to the crystalline MgO layer 5 including the vapor-phase MgO single crystal.

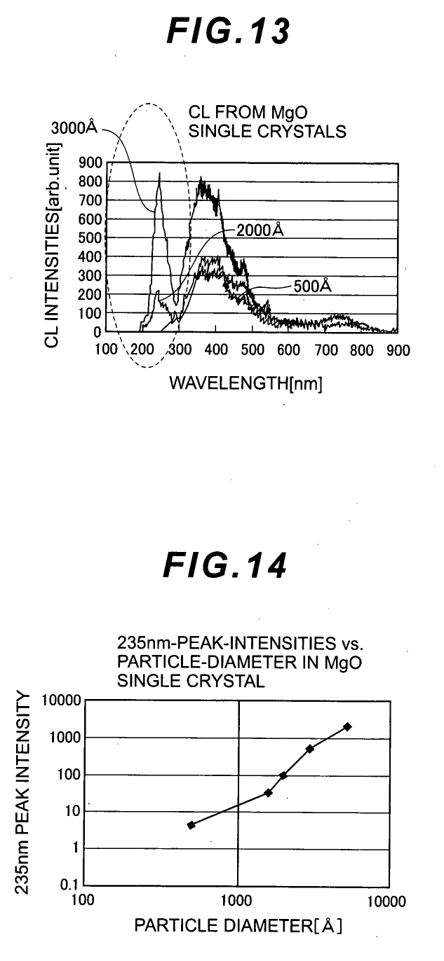

Because the crystalline MgO layer 5 is formed of the vapor-phase MgO single crystal as described earlier, in the PDP structured according to the present invention the application of an electron beam initiated by the discharge excites a CL emission having a peak within a wavelength range from 200 nm to 300 nm (more specifically, from 230 nm to 250 nm, around 235 nm), in addition to a CL emission having a peak wavelength from 300 nm to 400 nm, from the large-particle-diameter vapor-phase MgO single crystal included in the crystalline MgO layer 5, as shown in FIGS. 13 and 14.

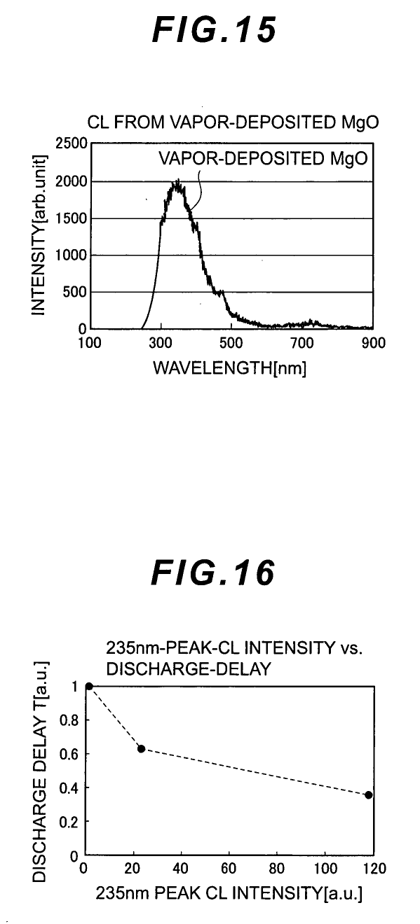

As shown in FIG. 15, a CL emission with a peak wavelength of 235 nm is not excited from a MgO layer formed typically by vapor deposition (the thin-film MgO layer 4 in the embodiment), but only a CL emission having a peak wavelength of between 300 nm and 400 nm is excited.

In addition, as seen from FIGS. 13 and 14, the greater the particle diameter of the vapor-phase MgO single crystal, the stronger the peak intensity of the CL emission having a peak within the wavelength range from 200 nm to 300 nm (more specifically, from 230 nm to 250 nm, around 235 nm).

It is estimated that the presence of a CL emission having a peak wavelength of between 200 nm and 300 nm will bring about a further improvement of the discharge characteristics (a reduction in discharge delay, an increase in the discharge probability).

More specifically, the estimated reason that the crystalline MgO layer 5 causes the improvement in the discharge characteristics is because the vapor-phase MgO single crystal causing the CL emission having a peak within the wavelength range from 200 nm to 300 nm (particularly, from 230 nm to 250 nm, around 235 nm) has an energy level corresponding to the peak wavelength, so that the energy level enables the trapping of electrons for a long time (some msec. or more), and the trapped electrons are extracted by an electric field so as to serve as the primary electrons required for starting a discharge.

Also, because of the correlationship between the intensity of the CL emission and the particle diameter of the vapor-phase MgO single crystal, the stronger the intensity of the CL emission having a peak within the wavelength range of from 200 nm to 300 nm (more specifically, from 230 nm to 250 nm, around 235 nm), the greater the effect of improving the discharge characteristics caused by the vapor-phase MgO single crystal.

In other words, in order to form a vapor-phase MgO single crystal of a large particle diameter, an increase in the heating temperature for generating magnesium vapor is required. Because of this, the length of the flame with which magnesium and oxygen react increases, and therefore the temperature difference between the flame and the surrounding ambience increases. Thus, it is conceivable that the larger the particle diameter of the vapor-phase MgO single crystal, the greater the number of energy levels occurring in correspondence with the peak wavelengths (e.g. within a range of from 230 nm to 250 nm, around 235 nm) of the CL emission as described earlier.

It is further estimated that in the case of a vapor-phase MgO single crystal of a cubic polycrystal structure, many plane defects occur, and the presence of energy levels arising from these plane defects contributes to an improvement in discharge probability.

The BET specific surface area (s) is measured by a nitrogen adsorption method. From the measured value, the particle diameter (D_{BET}) of the vapor-phase MgO single crystal forming the crystalline MgO layer 5 is calculated by the following equation.

D_{BET}=A/s×ρ

where A: shape count (A=6)
ρ: real density of magnesium

FIG. 16 is a graph showing the correlationship between the CL emission intensities and the discharge delay.

It is seen from FIG. 16 that the display delay in the PDP is shortened by the 235-nm CL emission excited from the crystalline MgO layer 5, and further as the intensity of the 235-nm CL emission increases, the discharge delay time is shortened.

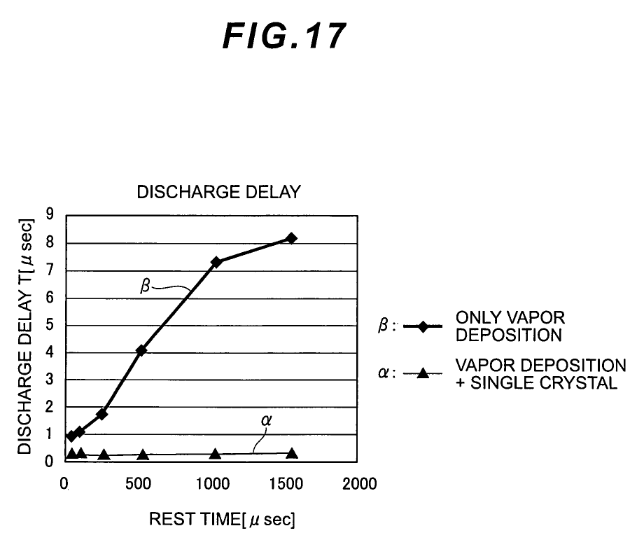

FIG. 17 shows the comparison of the discharge delay characteristics between the case of the PDP having the double-layer structure of the thin-film MgO layer 4 and the crystalline MgO layer 5 as described earlier (Graph α), and the case of a conventional PDP having only an MgO layer formed by vapor deposition (Graph β).

As seen from FIG. 17, the double-layer structure of the thin-film MgO layer 4 and the crystalline MgO layer 5 of the PDP offers a significant improvement in the discharge delay characteristics of the PDP over that of a conventional PDP having only a thin-film MgO layer formed by vapor deposition.

As described hitherto, in addition to the conventional type of the thin-film MgO layer 4 formed by vapor deposition or the like, the crystalline MgO layer 5, which includes the MgO crystal causing a CL emission having a peak within a wavelength range from 200 nm to 300 nm upon excitation by an electron beam, is formed, whereby the PDP structured according to the present invention enables an improvement in the discharge characteristics such as those relating to the discharge delay, and thus can show satisfactory discharge characteristics.

The MgO crystal used for forming the crystalline MgO layer has an average particle diameter of 500 or more angstroms based on a measurement using the BET method, desirably, of a range of from 2000 angstroms to 4000 angstroms.

As described earlier, the crystalline MgO layer 5 is not necessarily required to overlie the entire face of the thin-film MgO layer 4, and may be partially formed by a patterning technique, for example, on a portion of the thin-film MgO layer 4 facing the transparent electrodes Xa and Ya of the row electrodes X and Y or conversely on the portion other than the portion facing the transparent electrodes Xa and Ya.

When the crystalline MgO layer 5 is partially formed, the area ratio of the crystalline MgO layer 5 to the thin-film MgO layer 4 is set at 0.1% to 85%, for example.

The foregoing has described the example when the present invention applies to a reflection type AC PDP having the front glass substrate on which row electrode pairs are formed and covered with a dielectric layer and the back glass substrate on which phosphor layers and column electrodes are formed. However, the present invention is applicable to various types of PDPs, such as a reflection-type AC PDP having row electrode pairs and column electrodes formed on the front glass substrate and covered with a dielectric layer, and having phosphor layers formed on the back glass substrate; a transmission-type AC PDP having phosphor layers formed on the front glass substrate, and row electrode pairs and column electrodes formed on the back glass substrate and covered with a dielectric layer; a three-electrode AC PDP having discharge cells formed in the discharge space in positions corresponding to the respective intersections between row electrode pairs and column electrodes; a two-electrode AC PDP having discharge cells formed in the discharge space in positions corresponding to the respective intersections between row electrodes and column electrodes.

Further, the foregoing has described the example when the crystalline MgO layer 5 is formed through affixation by use of a spraying technique, an electrostatic coating technique or the like. However, the crystalline MgO layer 5 may be formed through application of a coating of a paste including an MgO crystal powder by use of a screen printing technique, an offset printing technique, a dispenser technique, an inkjet technique, a roll-coating technique or the like. Alternatively, a coating of a paste including an MgO crystal may be applied on a support film and then be dried to go into film form. Then, the resulting film may be laminated on the thin-film MgO layer.

Still further, the foregoing has described the example when the crystalline MgO layer 5 includes an MgO crystal. However, it is possible to provide the same effects even if the MgO crystal is simply sprayed on the dielectric layer and does not form a layer.

The PDP of the aforementioned embodiment is based on a first basic idea that the dielectric layer, which overlies the row electrode pairs provided on the inner face of a substrate, is formed of a dielectric material of a relative dielectric constant of 9 or less, and a protective layer overlying the dielectric layer includes magnesium oxide crystal that causes a cathode-luminescence emission having a peak within a wavelength range of 200 nm to 300 nm upon excitation by electron beams.

In the PDP based on the first basic idea, occurrence of a luminance residual image on the panel is restrained by having the dielectric layer formed of a low-relative-dielectric-constant dielectric material of a relative dielectric constant of 9 or less. In addition, a rise in the breakdown voltage and the occurrence of a discharge delay, which are caused by the use of a low-relative-dielectric-constant dielectric material to form the dielectric layer, is restrained by the fact that the protective layer covering the dielectric layer includes a magnesium oxide crystal which causes a cathode-luminescence emission having a peak within a wavelength range of 200 nm to 300 nm upon excitation by electron beams. In consequence, it is possible to achieve simultaneously the improvement of the panel residual image characteristics, the improvement of the discharge delay characteristics and the prevention of a rise in the breakdown voltage.

The PDP of the aforementioned embodiment is based on a second basic idea that the dielectric layer, which overlies the row electrode pairs provided on the inner face of a substrate, is formed of a dielectric material of a relative dielectric constant of 9 or less, the protective layer overlying the dielectric layer includes a magnesium oxide crystal that causes a cathode-luminescence emission having a peak within a wavelength range of 200 nm to 300 nm upon excitation by electron beams, and the discharge gas filling the discharge space includes 10% or more xenon by volume.

The PDP based on the second basic idea is capable of achieving a significantly higher light-emitting efficiency than that in conventional PDPs due to the fact that the dielectric layer is formed of a low-relative-dielectric-constant dielectric material of a relative dielectric constant of 9 or less in addition to the fact that the discharge gas filling the discharge space is a high-xenon gas including 10% or more xenon by volume. Further, the PDP can eliminate the occurrence of the discharge delay caused by an increase in xenon in the discharge gas and a decrease in the relative dielectric constant and also can achieve a further improvement in discharge delay characteristics as compared with that in conventional PDPs, because the protective layer overlying the dielectric layer includes a magnesium oxide crystal.

The terms and description used herein are set forth by way of illustration only and are not meant as limitations. Those skilled in the art will recognize that numerous variations are possible within the spirit and scope of the invention as defined in the following claims.

What is claimed is:

1. A surface-discharge-type plasma display panel, comprising:
a pair of substrates facing each other across a discharge space;
row electrode pairs and column electrodes provided between the pair of substrates, placed at a distance from each other, and extending in directions at right angles to each other to form unit light emission areas in positions corresponding to intersections in the discharge space;
a dielectric layer overlying the row electrode pairs; and
a protective layer overlying the dielectric layer and facing the unit light emission areas, wherein
the discharge space is filled with a discharge gas,
the dielectric layer is formed of a dielectric material having a relative dielectric constant of 9 or less, and
the protective layer includes a magnesium oxide crystal that causes a cathode-luminescence emission having a peak within a wavelength range of 200 nm to 300 nm upon excitation by electron beams.

2. A surface-discharge-type plasma display panel according to claim 1, wherein the dielectric layer is formed of a leadless glass material having a relative dielectric constant of 8 or less.

3. A surface-discharge-type plasma display panel according to claim 1, wherein the dielectric layer is formed of a Zn—B—Si alkali-containing glass material having a relative dielectric constant of 7 or less.

4. A surface-discharge-type plasma display panel according to claim 3, wherein the relative dielectric constant of the dielectric material in the dielectric layer is 6.8.

5. A surface-discharge-type plasma display panel according to claim 1, wherein the protective layer comprises a thin-film magnesium oxide layer deposited by vapor deposition or by spattering, and a crystalline magnesium oxide layer including a magnesium oxide crystal and deposited and laminated on the thin-film magnesium oxide layer.

6. A surface-discharge-type plasma display panel according to claim 1, wherein the magnesium oxide crystal is a magnesium oxide single crystal produced by a vapor-phase oxidization technique.

7. A surface-discharge-type plasma display panel according to claim 1, wherein the magnesium oxide crystal causes a cathode-luminescence emission having a peak within a wavelength range of 230 nm to 250 nm.

8. A surface-discharge-type plasma display panel according to claim 1, wherein the magnesium oxide crystal has a particle diameter of 2000 or more angstroms.

9. A surface-discharge-type plasma display panel, comprising:
a pair of substrates facing each other across a discharge space;
row electrode pairs and column electrodes provided between the pair of substrates, placed at a distance from each other, and extending in directions at right angles to each other to form unit light emission areas in positions corresponding to intersections in the discharge space;
a dielectric layer overlying the row electrode pairs; and
a protective layer overlying the dielectric layer and facing the unit light emission areas, wherein
the discharge space is filled with a discharge gas,
the dielectric layer is formed of a dielectric material having a relative dielectric constant of 9 or less,
the protective layer includes a magnesium oxide crystal that causes a cathode-luminescence emission having a peak within a wavelength range of 200 nm to 300 nm upon excitation by electron beams, and
the discharge gas includes 10% or more xenon by volume.

10. A surface-discharge-type plasma display panel according to claim 9, wherein the dielectric layer is formed of a leadless glass material having a relative dielectric constant of 8 or less.

11. A surface-discharge-type plasma display panel according to claim 9, wherein the dielectric layer is formed of a Zn—B—Si alkali-containing glass material having a relative dielectric constant of 7 or less.

12. A surface-discharge-type plasma display panel according to claim 11, wherein the relative dielectric constant of the dielectric material in the dielectric layer is 6.8.

13. A surface-discharge-type plasma display panel according to claim 9, wherein the discharge gas includes 15% xenon by volume.

14. A surface-discharge-type plasma display panel according to claim 9, wherein the protective layer comprises a thin-film magnesium oxide layer deposited by vapor deposition or by spattering, and a crystalline magnesium oxide layer including a magnesium oxide crystal and deposited and laminated on the thin-film magnesium oxide layer.

15. A surface-discharge-type plasma display panel according to claim 9, wherein the magnesium oxide crystal is a magnesium oxide single crystal produced by a vapor-phase oxidization technique.

16. A surface-discharge-type plasma display panel according to claim 9, wherein the magnesium oxide crystal causes a cathode-luminescence emission having a peak within a wavelength range of 230 nm to 250 nm.

17. A surface-discharge-type plasma display panel according to claim 9, wherein the magnesium oxide crystal has a particle diameter of 2000 or more angstroms.
